(19) United States
(12) Patent Application Publication
(10) Pub. No.: US 2009/0323655 A1
(43) Pub. Date: Dec. 31, 2009

(54) SYSTEM AND METHOD FOR INVITING AND SHARING CONVERSATIONS BETWEEN CELLPHONES

(75) Inventors: Javier Cardona, San Francisco, CA (US); Alejandro Herrera Pero, Barcelona (ES); Andrey Yurovsky, San Francisco, CA (US)

Correspondence Address: ABELMAN, FRAYNE & SCHWAB, 666 THIRD AVENUE, 10TH FLOOR, NEW YORK, NY, 10017, US

(73) Assignee: Cozybit, Inc., San Francisco, CA (US)

(21) Appl. No.: 12/415,569

(22) Filed: Mar. 31, 2009

Related U.S. Application Data
(60) Provisional application No. 61/040,872, filed on Mar. 31, 2008.

(51) Int. Cl. H04W 4/00

(52) U.S. Cl. 370/338

(57) ABSTRACT

A system and method perform wireless networking that allows a cellular phone user to invite and share conversations with other cellphones or wireless communication devices in local spatial proximity by means of a wireless mesh or infrastructure or an ad-hoc network. In the system and method, there is no per-minute cost by using wireless local area networks in the unlicensed spectrum, such as a 802.11 network. Conversations are shared with only the intended persons. To join a conversation using the method, users only require any wireless device, and not necessarily a cellphone, such as a laptop with wireless capability.

### CROSS-REFERENCE TO RELATED APPLICATIONS

This application is based on U.S. provisional application No. U.S. 61/040,872, filed on Mar. 31, 2008.

### BACKGROUND OF THE INVENTION

1. Field of the Invention

This invention relates to wireless communications, and in particular to a network configuration for use with cell phones which provides an application of wireless networking that allows a cellular phone user to invite and share conversations with other cellphones or wireless communication devices in local spatial proximity by means of a wireless mesh or infrastructure or an ad-hoc network.

2. Description of the Related Art

Communication systems are known which provide communications between devices, including conference calls. U.S. Published Patent Publication Number US2006/0215585 describes a remote conference terminal 210 in FIG. 4, a local conference terminal 110, and a mobile terminal 16, all of which communicate via the same network 30 shown in FIG. 1 and described in paragraph 0040.

This differs from the present invention of having a local area wireless mesh network provide access to the conference to all local wireless nodes. In US2006/0215585, mobile nodes require additional infrastructure such as LAN Access Points, and conference administrating apparatus described in paragraphs 0050 and 0055, to join a conference. The main intent seems to allow users to “move away” from the main conference terminal and relay state (authentication) to a mobile node, as described in paragraph 0042.

U.S. Published Patent Publication Number US2007/0123239 allows mobile systems to join a teleconference bridge. The bridge is accessed via a WAN, not a local area wireless mesh network. U.S. Published Patent Publication Number US2008/0039065 uses a push-to-talk architecture for cellphones. U.S. Published Patent Publication Number US2005/0135279 describes a conferencing system.

U.S. Pat. No. 6,522,633 describes a teleconference bridge for network providers which works at the WAN level. U.S. Pat. No. 6,163,692 provides an improvement for reconnecting to a teleconferencing bridge.

U.S. Published Patent Publication Number US2003/0044654 has a second communication manner which may include Bluetooth, while the present invention excludes Bluetooth as a second communication manner, and the present invention further includes other communication techniques such as 802.11 mesh, 802.11 ad-hoc, 802.11 peer-to-peer, and 802.11 infrastructure modes, which are not described or suggested in U.S. Published Patent Publication Number US2003/0044654.

In addition, U.S. Published Patent Publication Number US2003/0044654 fails to describe or suggest how a number of key mechanisms can be implemented. For example, discovery of “proximate wireless devices” is important to the present invention, but U.S. Published Patent Publication Number US2003/0044654 states that “This can be accomplished by the primary wireless device broadcasting a discovery signal” which requires a device acting as a “primary wireless device”, which is the device making the long distance call, and so must be present at all times.

In the present invention, a local conference may be established before a call is made; and therefore, the present invention does not rely on a “primary wireless device” to perform the discovery. Instead, the present invention uses a distributed query-response mechanism standardized by IETF, as well as mDNS-Service Discovery, such as draft-cheshire-dnsext-multicastdns.txt. With this mechanism, any conference participant can link the local conference to an external party. This mechanism used by the present invention also allows multiple conference participants to be simultaneously connected to remote parties. In other words, in a local conference of N participants, there may be 0-N participants who are also connected to remote parties. Thus the maximum number of participants can be 2*N, with N local participants and N remote participants.

In addition, in conferencing system, determination of the identity of the “proximate wireless devices” and whether a user wants to invite such devices to join the conference is important to the present invention. However, U.S. Published Patent Publication Number US2003/0044654 states, in paragraph 0022, that “the primary wireless device invites desired ones of the local communicatively proximate wireless devices of which it is aware to join the external call”. Such a description does not explain how to determine “desirability”.

Therefore, U.S. Published Patent Publication Number US2003/0044654 lacks any disclosure or suggestion regarding determining if such phones are within visible range. Even in the case that the system in U.S. Published Patent Publication Number US2003/0044654 determines phones are within visible range, the system in U.S. Published Patent Publication Number US2003/0044654 does not disclose any mapping of a response to a discovery message from a phone to a name of a person, does not address privacy, and does not disclose or suggest whether phones broadcasts the names of the phone owners.

On the contrary, the present invention has a distributed authentication mechanism that uses the information on each address book of each phone to determine whether the other party is “known” and his/her identity, which ensures privacy. Nodes broadcast a cryptographic signature that recipients try to match against existing entries in their address book.

In addition, mixing audio signals from different participants, which may be local and remote, is a difficult problem. U.S. Published Patent Publication Number US2003/0044654 does not disclose or suggest where such mixing is performed, whether in hardware or software, or in which processor, as well as failing to describe what are the paths of the audio signals. The present invention addresses such deficiencies of U.S. Published Patent Publication Number US2003/0044654 regarding the mixing of audio signals in one or more platforms.

U.S. Pat. No. 6,405,027 also presents disadvantages in the prior art, since column 2, lines 66-67 describes that “the communication devices or terminals D2 through Dn are engaged in calls with handset or device Do over respective wireless direct device-to-device duplex links, each using the Bluetooth Intercom profile”, and that a “direct device-to-device second link is implemented in accordance with the Bluetooth Intercom Profile”.

In the present invention, the use of a 802.11 infrastructure or an ad-hoc 802.11 or mesh is superior to the use of Bluetooth in a number of ways. For example, the 802.11 system has a longer range of about ten times the range of Bluetooth systems, which allows for local terminals to be further apart than when Bluetooth is used. In addition, a 802.11 systems provides about twenty times the bandwidth of Bluetooth, which can support a bigger number of conference participants with better sound quality.

Also, a phone implementing 802.11 may connect to a local wired IP network, which extends the range at which the present invention can connect with local conference participants even further. A node with Bluetooth as in the prior art, on the other hand, cannot connect directly to an IP network.

Furthermore, since 802.11 provides direct connection to an IP network, 802.11 systems allow for the use of standard audio streaming and session management protocols such as RTP and SIP, which are not implemented for Bluetooth. Also, the 802.11 protocol already includes security and encryption mechanisms at layer 2 which can provide privacy to conference participants. In particular, a mesh, and not just infrastructure or ad-hoc 802.11, as in the present invention, has these additional advantages over Bluetooth.

In addition, in the present invention, the range increases with the number of participants, as the coverage area of the network increases with each additional node that joins. As an example of this increase range, if a conference takes place in an office, and one of the participants walks out of the room while in conference, if the phone is mesh-capable, any other mesh-capable laptop in the path between the nodes can forward traffic and provide coverage to the person that walked away.

When using an extended range, as in the present invention, a number of problems may be encountered which U.S. Pat. No. 6,405,027 does not address, such as how to determine the identity of “proximate wireless devices”, and whether a user wants to invite such proximate wireless devices to join the conference. Unlike U.S. Pat. No. 6,405,027, the present invention proposes a solution to these problems.

For the same reasons described herein for U.S. Pat. No. 6,405,027, U.S. Published Patent Publication Number 2006/0240817 uses exclusively Bluetooth and so includes the previously described disadvantages which the present invention addresses and overcomes.

Also in the prior art, U.S. Pat. No. 6,532,369 has mobile nodes which implement the functionality of a network base station, not 802.11 as in the present invention.

In the prior art, U.S. Published Patent Publication Number US2008/0233990 describes a method of implementing push-to-talk with SIP and multicast RTP similar to the present invention, and introduces a central SIP server to relay SIP messages to a PTT server which is different from the approach of the present invention in that the present invention uses a fully distributed architecture in which each node is capable of acting as a SIP server. The present invention also uses multicast messages instead of unicast messages relayed by a central server. Furthermore, U.S. Published Patent Publication Number US2008/0233990 uses PTT technology, half-duplex communications and a central server for designing a large scale system. However, multicast using the system in U.S. Published Patent Publication Number US2008/0233990 is not reliable beyond local networks, while multicasting in the present invention is reliable.

U.S. Pat. No. 5,666,661 in the prior art describes a method to swing from WAN connection to direct link between phones, but such a system does not use two separate radios, nor links local parties with remote parties, as in the present invention.

Also in the prior art, U.S. Pat. No. 7,236,773 is limited to N local participants, 1 remote, while the present invention can handle N local plus N remote; that is, one remote per local. In addition, U.S. Pat. No. 7,236,773 does not provide a way to determine desirability of participants, and does not describe any details about how to perform audio mixing, which are addressed and performed in the present invention.

In addition, in the prior art, cellular phone connections cannot be shared in the same way as is possible with conventional land line phones. In a wired telephone installation with multiple phones, a person can join a conversation by picking up one of the inactive handsets. There can be as many people joining the conversation as telephones in the wired telephone installation. The quality of the sound is good, as each person has its own handset, and there is no additional cost to the communication, independently of the number of people who join the call.

With known cellphones this is not possible. In known cellphone systems, if a cellphone user wants to invite a nearby third person to join a call, he or she can turn on the loudspeaker of the cellphone if present, or alternatively make a N-way call if supported by network.

The first option degrades the audio quality of the conversation: the audio quality produced by this method is usually worse as parties must place the headset further away so that the microphone can pick up the voice of all the participants. Another disadvantage of this method is that the conversation may be overheard by other people and/or annoy people in the vicinity.

The second option works well, but it normally has an additional cost, as each person participating in the call pays for its communication time. Also, each person joining the conversation using this method needs to have a cellphone and cellphone service.

### BRIEF SUMMARY OF THE INVENTION

The present invention details a novel application of wireless networking that allows a cellular phone user to invite and share conversations with other cellphones or wireless communication devices in local spatial proximity by means of a wireless mesh or infrastructure or a wireless ad-hoc network.

The wireless mesh may include an IEEE 802.11 mesh Basic Service Set system, the wireless infrastructure may include an IEEE 802.11 infrastructure Basic Service Set system, and the wireless ad-hoc network may include an IEEE 802.11 independent Basic Service Set system.

The method of the present invention combines the advantages of both methods mentioned above with none of their disadvantages. In particular, the method of the present invention has no per-minute cost, as it uses wireless local area networks in the unlicensed spectrum, such as a 802.11 network. In addition, using the method of the present invention, the conversation is shared with only the intended persons. Furthermore, to join a conversation using the disclosed method, users only require any wireless device, and not necessarily a cellphone, such as a laptop with wireless capability.

Local Conferences require no support infrastructure and can be established anywhere two or more WCTs can establish a mesh or an ad-hoc network.

While the main goals of the invention can be achieved over a wireless ad-hoc network, as defined in IEEE Std. 802.11 2007, the use of a wireless mesh network, as defined by the IEEE Task Group S, and implemented by the present invention, is preferred as such a wireless mesh network would provide additional advantages. One advantages is that a wireless mesh network provides an extensible range that grows as the number of participants in the conference grows.

Another advantage is that a wireless mesh network can be configured to connect users communicating using different channels, which provides a larger bandwidth that can accommodate more conference participants. A further advantage is that a wireless mesh network, capable of multi-hop links and transmission power control, can result in lower power consumption, a critical element for a battery powered device such as a cellphone.

WAN Conferences only require whatever infrastructure is necessary to provide WAN access to one of the Local Conference participants.

Alternatively, the device-to-device connection may also be established using 802.11 frames in a peer-to-peer fashion. In this mode, a standard 802.11 ad-hoc network is created, or one of the parties acts as an 802.11 access point, as defined in IEEE Std. 802.11 2007, and all other conference participants associate to the access point as mobile stations. This alternative method requires an initial negotiation to determine which node is to act as an access point, as well as provisions to handle the case when that node leaves the conference.

If the WAN is capable of providing data services, for example, Internet access via GPRS, 3-G, EDGE, etc., the same principle described in the present invention may be used to extend those to all other conference participants. In this case, the data traffic between WCTs and the Internet would be bridged by the WAN capable node.

Known and commercially available WI-FI radios in cellphones are used to provide a fast data connection to the Internet. The present invention uses the fast data connection for device-to-device connectivity in a local area network; that is, inside a network that is locally administered and may or may not be connected to the Internet.

### BRIEF DESCRIPTION OF THE SEVERAL VIEWS OF THE DRAWINGS

Preferred embodiments of the invention are disclosed hereinbelow with reference to the drawings.

FIG. 1 is a block diagram of the audio system in a WI-FI capable cellphone of the present invention.

FIG. 2 is a network diagram.

FIGS. 3-5 are audio path diagrams.

FIGS. 6A-7E are example user interfaces.

FIG. 8 is a flowchart of an audio application.

FIG. 9 shows an audio codec configuration on three phones used in the present invention.

FIG. 10 is a network in which the present invention operates.

FIG. 11 is a software network architecture in which the present invention operates.

### DETAILED DESCRIPTION OF THE INVENTION

The following terms are used herein in conjunction with the present invention.

A Wireless Conference Terminal (WCT) is a device capable of picking up audio from a microphone, reproducing audio on a speaker, and transmitting and receiving audio streams over a wireless mesh or infrastructure or ad-hoc network.

A WAN Capable Wireless Conference Terminal (WWCT) is a WCT that is also capable of subscribing and using a Wide Area Network such as GSM or CDMA.

A Conference Initiator is the WCT that first starts sending conference announcements to other WCTs.

An Invited Party is any of the WCTs that receives a conference announcement.

A Remote Party is any conference participant that communicates with WCTs via a Wide Area Network (GSM/CDMA).

A Local Conference is a conference established between WCTs in which none of them is connected to a WAN.

A WAN Conference is a conference established between WCTs in which one or more of them are connected to a WAN.

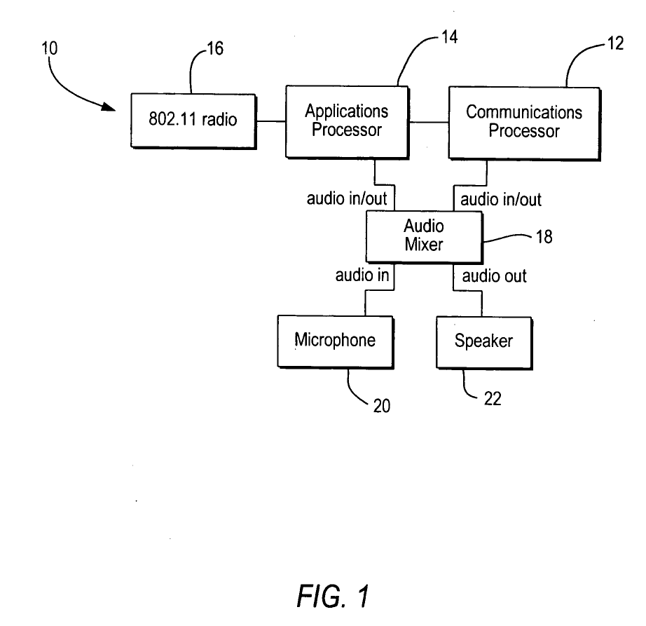

Referring to FIGS. 1-11, the present invention provides a wireless networking system and method using network components, hardware, and software that allow a cellular phone user to invite and share conversations with other cellphones or wireless communication devices in local spatial proximity by means of a wireless mesh or infrastructure or ad-hoc network. The wireless mesh may include an IEEE 802.11 mesh Basic Service Set system, the wireless infrastructure may include an IEEE 802.11 infrastructure Basic Service Set system, and the wireless ad-hoc network may include an IEEE 802.11 independent Basic Service Set system. Other wireless networking components may be used, and may include IEEE 802.11-based peer-to-peer systems.

An ad-hoc network as in the present invention allows for direct, single-hop device-to-device links, standardized in the IEEE 802.11 methodology. A wireless infrastructure as in the present invention uses an access point to create networks, for example, in a star topology, with the access point at the center, as standardized in the IEEE 802.11 methodology, which is typically referred to as WIFI. A wireless mesh as in the present invention allows multi-hop device-to-device links, which may be standardized as is known in the art, for example, by the 802.11 Task Group S. Peer-to-peer, as in the present invention, provides a better ad-hoc configuration that allows secure direct, single-hop device-to-device links, which may be standardized as is known in the art, for example, by the “WIFI ALLIANCE”.

Such wireless mesh or infrastructure or ad-hoc networks or peer-to-peer systems are a preferred embodiment and are the best mode of the present invention, and the present invention excludes the use of Bluetooth systems and methods, due to the limitations of Bluetooth known the art, in which regard wireless mesh or infrastructure or ad-hoc networks or peer-to-peer systems, using IEEE 802.11-based systems and methods, as used in the present invention, provide superior functionality and operating characteristics compared to known Bluetooth systems.

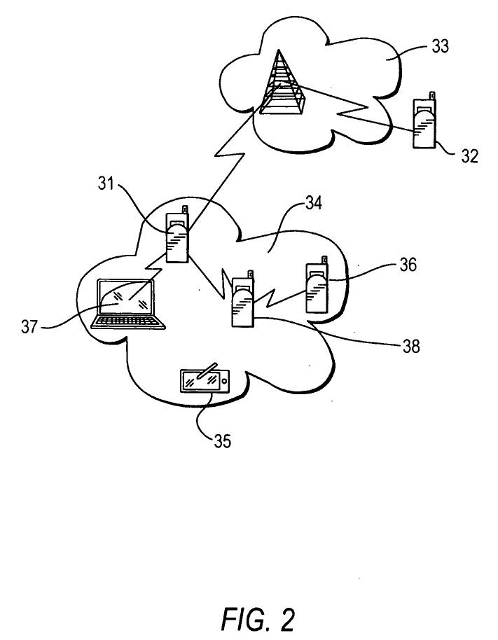

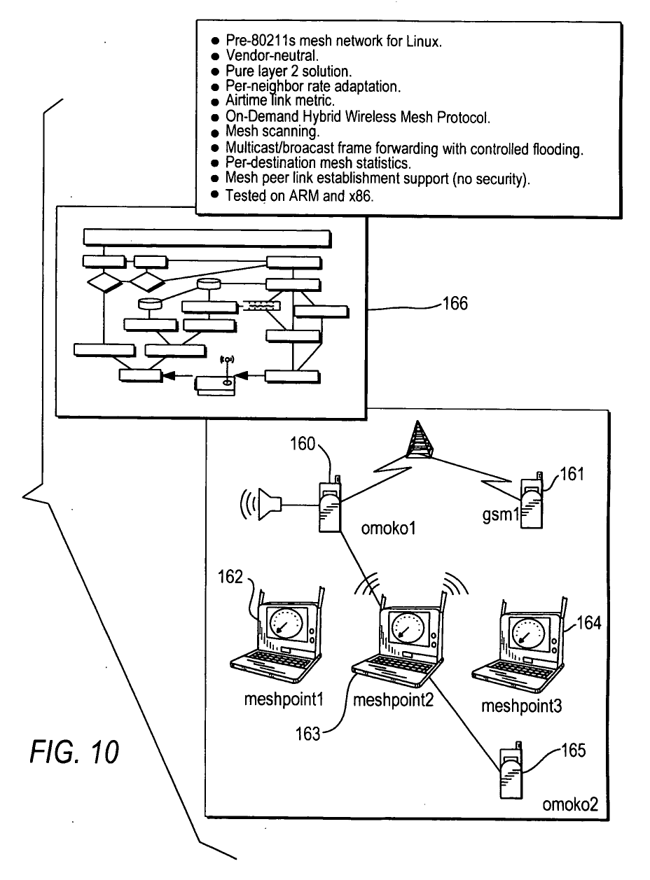

FIG. 1 shows a block diagram of the subsystems in a cellphone 10 relevant to the present invention, for use in a network shown in FIGS. 2 and 10. The base system of the cellphone 10 required for a first embodiment of the invention is a WI-FI capable cellphone. Modern cellphone designs include two separate processing units. One processing unit, commonly referred to as a communications or modem processor 12, is responsible for executing the cellphone network protocol, such as GSM, CDMA, etc.

The second processing unit, commonly referred to as an applications processor 14, controls the user interface and executes all the phone applications, such as a contact list, agenda, alarms, games, etc.

Known architectures are used in the present invention and are common in the industry. It can be found, for instance, in all cellphones based models OMAP 24xx and OMAP 34xx commercially available from “TEXAS INSTRUMENTS”, or models BCM21XX commercially available from “BROADCOM”, for example, as described in U.S. Published Patent Publication Number US2006/0129848, which is incorporated herein by reference in its entirety, and which provides a good overview of modern cellphone architectures.

The applications processor 14 is a general purpose processor optimized for embedded applications, such as low power consumption, a small footprint, etc. The most common processor family used for the applications processor are ARM processors.

The communications processor 12 is usually application-specific, that is, highly optimized to perform one specific task. In the case of the present invention, the communications processor 12 implements the wide area network communication protocol, such as CDMA, GSM, EDGE, etc. In WI-FI capable phones and other phones and communications devices compatible with the IEEE 802.11 standard, the communications processor 12 is also connected to a 802.11 radio 16 through the applications processor 14.

The cellphone 10 also includes an audio mixer module 18 connected to both the communications processor 12 and the applications processor 14 for processing audio in/out signals, and for receiving and processing audio-in signals from a microphone 20 as well as providing audio-out signals to a speaker 22, using known cellphone and electronic components.

Referring to FIG. 2, the following sequence of steps describes one example of use of the system and method of the present invention, in which a first user 31 establishes commendation with a second user 32 through a first network 33 as well as throughout a second network 34 local to the first user 31 and including other users using various communication devices 35-38, such as cellphones 36, 38, personal digitals assistants 35, and computers such as laptops 37.

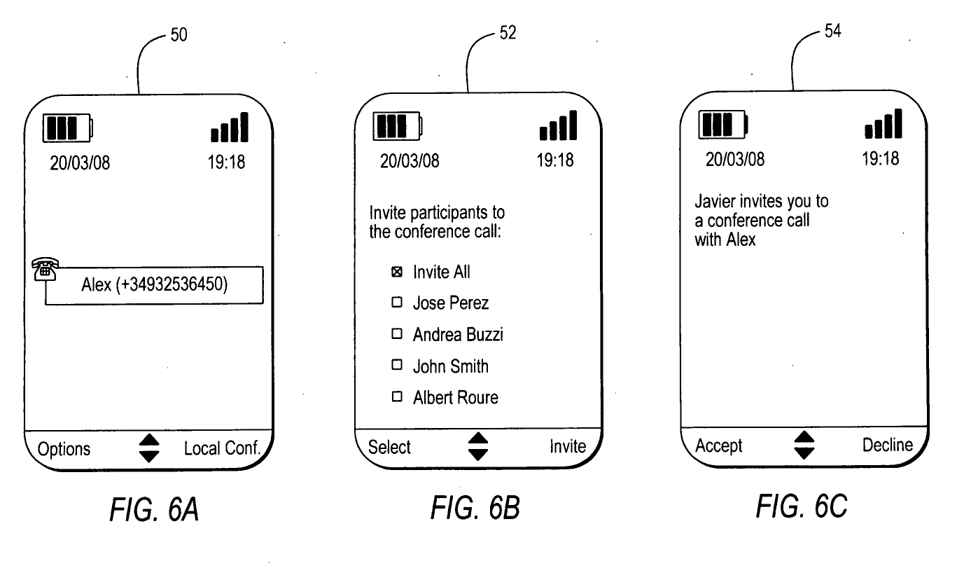

Step 1: the first user 31 dials the second user 32 and a cellphone communication is established over a wide area network 33, with an interface 50 shown in FIG. 6A.

Step 2: the first user 31 selects from a list of local wireless contacts 5-8 with whom to share the conversation, with an interface 52 shown in FIG. 6B. Only such wireless contacts that are reachable over the local wireless network, and also that are authenticated against a list of authorized contacts stored by cellphone, are presented to each user.

Step 3: the first user 31 presses a button to “Invite” the selected parties, as shown in the interface 54 in FIG. 6C.

Step 4: all the selected local wireless contacts receive an invitation to join the conversation between the first user 31 and the second user 32. Each user is notified via a visual, acoustic, or vibrating signal. The display on the device provides information about the call, for example, a “conference between the first user and the second user” or a “local conference invitation from the first user”. The displayed information may be tailored to include known information, such as the name of the first user.

Step 5: any of the local wireless devices may then accept the invitation and join the call, as shown in the interface 54 in FIG. 6C.

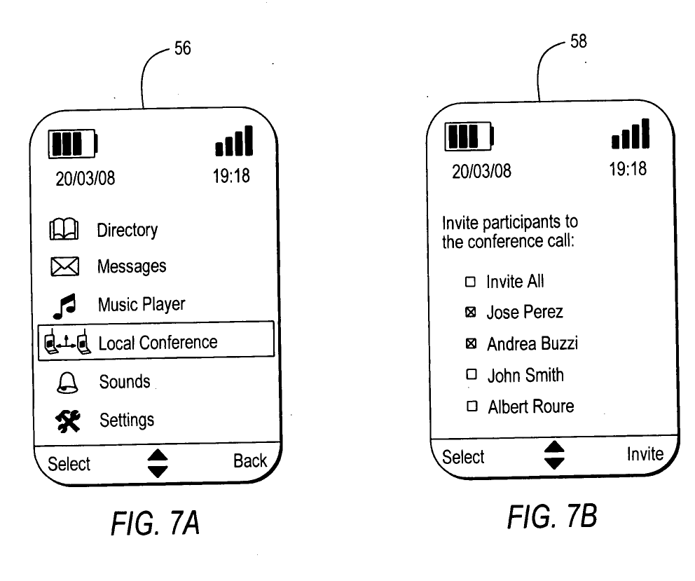

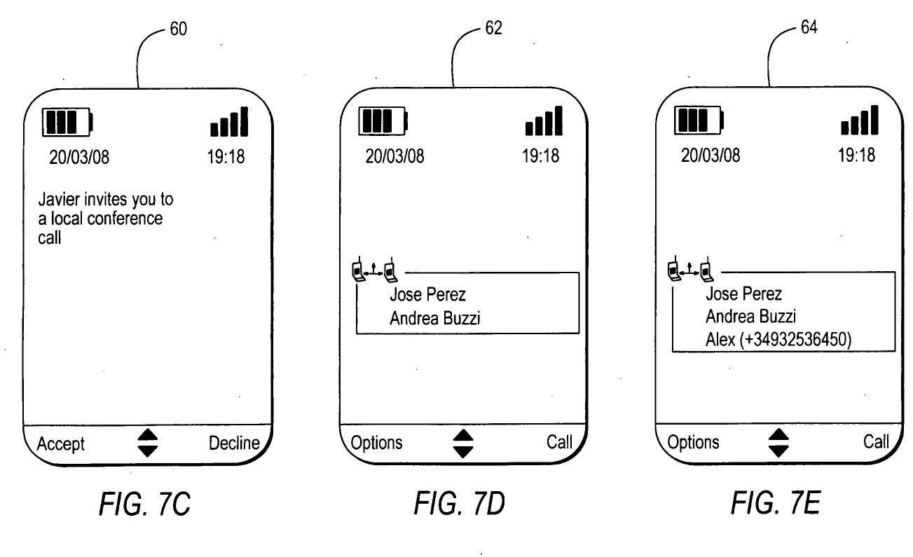

In alternative embodiments and variants of the present invention, the local wireless conference can be established before the cellphone communication is established, and may be initiated by any of the wireless capable devices and not just the WAN capable phones. This may be useful, for instance, for components 35 and 37 shown in FIG. 2, which may be non-WAN capable devices, to call user 31 and ask to dial out and establish a conference with user 32, as shown in FIGS. 7A-7E. FIGS. 7A-7E illustrate a series of interface displays 56-64 by which user 31 is called and asked to dial out and establish a conference with user 32. In another alternative embodiment, Step 2 above is optional. If skipped, all local wireless contacts are selected.

In the present invention, participant discovery is implemented, since the conference initiator needs to know which users can be invited to the local conference. Those are all the nodes that can be reached via the local wireless mesh or infrastructure or ad-hoc 802.11 network. The discovery of those nodes is made via a service discovery protocol such as DNS-SD, as defined by IETF RFC 2782) or UPnP. The first embodiment of the invention uses mDNS/DNS-SD to discover participants in the mesh network.

As described herein, participant authentication is performed. Participants are discovered by advertising information about users in a confidential manner. These advertisements are received by other nodes and used to build and present a list of available local participants in the conference. The service advertisement and discovery is implemented through mDNS-SD. The application advertises an UDP ServiceType or SRV. The SRV will include several TXT records used for finding matches in the Contacts Database of each phone. The contents of the TXT records are the described in Table 1, in which a one-way cryptographic function, such as sha1, is used, and a salt value is a random string known by both ends of the conversation.

TABLE 1

| TXT RECORD | SOURCE DATA | SHA1 HASHED? |
|---|---|---|
| s | salt phrase | no |
| n1 | lowercase(Last Name) | yes |
| n2 | lowercase(First Name) | yes |
| p1 | mobile phone number | yes |
| p2 | home phone number | yes |
| p3 | work phone number | yes |
| e1 | lowercase(home email address) | yes |
| e2 | lowercase(work email address) | yes |

Additional fields may also be optionally included. The first and last names are converted to lowercase before hashing. Phone numbers are treated as a string of digits, with no dashes or other non-digit characters, and exclude country and area code. TXT records are only added if there is data for the record in question. For example, e1 and e2 records are not present if there is no email address on file.

An example of application SRV record is as follows:
Service Type: _tok._udp
Service Name: tok
Domain Name: local
TXT sa=ekr5ktji16s6bc84de1badef1f15p84zsferkjlg
TXT p2=ad574fa11636bc847d1bafef1f160864dbae7c76
TXT p1=f52a54446c2fd2256f8e1a96621e59659dd560fb
TXT s=785a34afec179a8b8c44e7672eb9870a4f735693
TXT n1=f73d571325173f93d85b236c580e0b95bd0fb74f
TXT n2=28e1d51dddaacc89111eb0fdb3c67a1fd89b2c5a
TXT e1=147ace6380439cfb472d3328b8fdb904514950d8

In addition, contact database matching is performed. In the present invention, the application attempts to match each received service advertisement to an entry in the ContactDatabase of a phone, which is performed by choosing the contact for which there are the largest number of matches given the TXT records present and computed hashes for all of the entries in the database. The matching algorithm is as follows:

There are four categories: first name, last name, phone numbers, and email addresses. Each category has a weight for a match on any of its contents. All entries in a category on one “side” are matched with all entries on the other “side”. The weights are shown in Table 2.

TABLE 2

| Category | Weight |
|---|---|
| first name | 1 |
| last name | 1 |
| phone numbers | 2 |
| email addresses | 2 |

The present invention computes a certainty, defined as:

certainty value=(score×24)/n

where n is the number of categories that are available on both sides. The value “24” is a normalizing constant to avoid fractional certainty values. The certainty threshold is set to a predetermined value of 12; that is, a contact with a certainty of two or lower is not matched. A contact with a certainty higher than 12 is matched.

A maximum score is 13, and therefore the maximum certainty is 78. Note that the weights and threshold values are specific to one particular embodiment of the invention. In alternative embodiments, different values of weights and thresholds will result in different probabilities of false positives and false negatives triggered by slight differences in Address Book entries.

In the present invention, privacy and encryption are also performed. The goals of the neighbor identification mechanism are to account for differences between Contact records, such as “Andrey” instead of “andrey yurovsky”, to provide a reasonable level of privacy, and to require a minimal or no configuration.

Because of such privacy and encryption mechanism, no personal information in cleartext is sent until only after the personal information has been hashed with a one-way cryptographic function, such as sha1.

The sender would apply the hash to a number of records; for example, to telephone numbers, e-mails, firstname, lastname, and other records, and transmit the obtained signatures to the receiving end. For example, if a contact has one first name, one last name, two telephone numbers and three e-mails, the sender would produce 1+1+2+3=7 signatures for that contact. The receiving end then applies the hash to all the records in its contacts database and finds a match.

However, using a well known hashing function makes this approach susceptible to reverse lookup attacks. There are known systems and methods which allow reverse lookup of commonly used passwords, which are published and publicly and commercially available, for example, on the Internet at http://www.sha1-lookup.com/index.php and http://hashcrack.com/index.php. In one example, a specific predetermined phone number may be obtained by reverse lookup of its hash, such as88ee0cfb133eed1c565ea9e2e1cfd7f7ca3d0527, on such websites.

Furthermore, since phone numbers are less than the 20 byte output of the sha1 one-way function, there will be no collisions with other strings shorter than 20 characters. Therefore, there is no ambiguity in the reverse lookup of phone numbers.

A widely used method to mitigate this vulnerability is to prefix the input of the hash function with a salt; that is, a random string known by both ends of the conversation. The hash would be applied to the concatenation of salt and record.

The salt can be a fixed long string precompiled into the application, or a throw-away salt generated each time the application is launched. Using a throw-away salt makes it much harder to attack the encryption by reverse lookup but is more CPU intensive as signatures need to be recalculated anytime a new service announcement is received, such as by the “IKEETOK” system commercially available from “COZYBIT, INC.”. In the first embodiment of the present invention, the disclosed system and method uses throw-away salt strings.

On application launch, a N character random salt is generated. The recommended salt size is 40 characters, but the random number may be revisited if there are size restrictions in the strings that are transmitted in DNS-SD service announcements. One simple way to generate a random salt is to hash the output of date, such as by concatenating a date and a sha1sum value. Then the signatures for all the records listed in the Service Advertisement section are computed. All inputs to the sha1 algorithm are given in ASCII format. The receiver will use the salt received with the service announcement, provided in an sa field, to compute the signatures of all the names, phone and e-mail records in her contact database.

In the present invention, asymmetric authentication is performed. For example, in the case that a party A knows about party B, in which B is in the address book of A, but B does not know about A since, for example, A is not in the address book of B, the present invention uses a mechanism or method, as disclosed herein, to allow B to talk to A and to decide whether to add A to the address book of B.

The mechanism is as follows: if A discovers a new potential participant, such as via mDNS service discovery, who does not match one of the contacts of A, A sends a “do-I-know-you” message to the address of B, and B creates a response with the same contents as the mDNS announcement, generated from the record of A. That is, B generates a random salt, and hashes all the fields B knows about A, such as first name, last name, phones, e-mails, etc. That information is included in the response.

Then, A determines if the information in the response from B is sufficient to establish a match. For that, A creates a new service announcement with the received salt and attempts to match that announcement with the information in the reply. If there is not any match, the response is ignored. However, if the response is valid, an “unknown contact@B's address” appears on a peer list of A that A calls to find out who the unknown person is. Then the new person can be added to the Contacts list of A at a later time. However, A may decide to hide all or specific unknown contacts at any time.

As shown and described herein, various signaling paths are implemented. A conference session is started when the conference initiator presses the “invite” button. Note that the conference initiator does not necessarily have to be a GSM/CDMA capable node. In response to this action, a session announcement process starts transmitting session information messages to a multicast or group address being monitored by all local conference candidates. This is the well-known “all SIP servers” multicast address as defined in RFC3261 “SIP: Session Initiation Protocol”.

Using the SIP protocol, all participants find out the multicast address where the audio streams for the session will be sent. All conference participants transmit and receive audio on the same multicast address.

Audio streaming is done using a real time protocol, such as the one defined in RFC 3550. The protocol provides a way for each participant to multiplex the different streams received from each conference participant and so be able to correctly mix audio from different sources.

Alternatively, the session announcement process starts transmitting session information messages to the selected local wireless nodes. The format of these messages will typically follow the protocol of the IETF in the Session Description Protocol RFC4566. These announcements may be transmitted to a multicast address in a one-to-many mode, or to unicast addresses in a one-to-one mode. The choice should be made based on the number of intended recipients and the characteristics of the wireless network, for example, in a noisy environment one-to-one messages provide higher reliability. When a local wireless device receives a session information message, the user is notified and presented with the option to accept or decline the invitation. If the invited party decides to join, it will start a full-duplex audio session with the conference initiator.

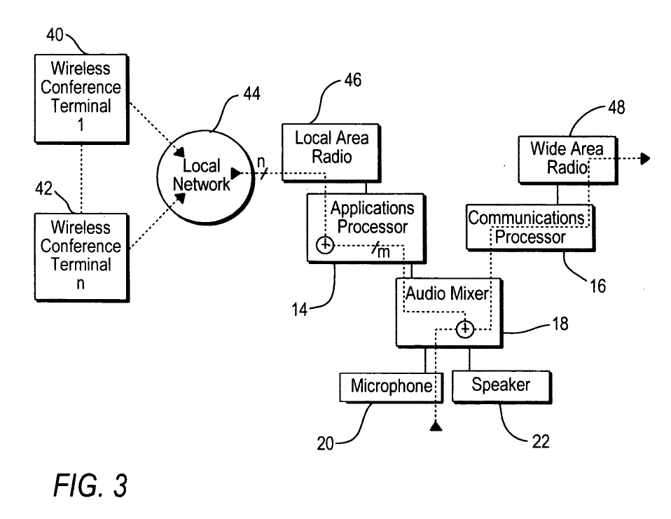

The present invention utilizes audio paths as shown in FIGS. 3-5, which illustrate the audio paths through the conference system once a conference session has been established.

As shown in FIG. 3, audio originating at any of the WCTs 40, 42 is transmitted over the wireless mesh or infrastructure or ad-hoc 802.11 network 44 and received by the applications processor 14 of the cellphone 10 of a user via the 802.11 radio 16 incorporated into a local area radio 46. Audio is then trans-coded into a format suitable for the audio mixer module 18. In the case where the audio mixer module 18 cannot accept as many audio channels as are received over the network, the applications processor 14 will perform software mixing of the received software streams.

This audio output will be mixed by the mixer 18 with the local microphone audio and output to the communications processor 12 for transmission to the remote party through a wide area radio 48.

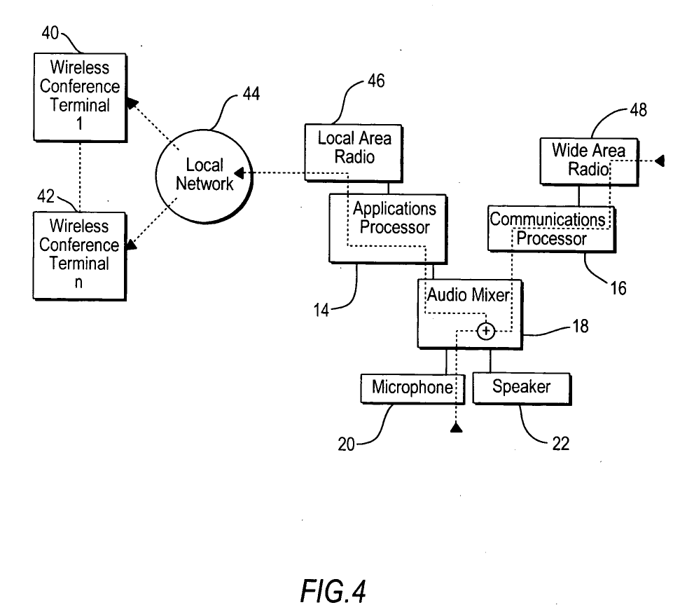

As shown in FIG. 4, audio originating at the remote GSM/CDMA phone is transmitted over the Wide Area Network, received by the WAN antenna of the wide area radio 48, and processed by the communications processor 12. Audio is then trans-coded into a format suitable for the audio mixer module 18. This audio output will be mixed by the mixer 18 with the local microphone audio and output to the applications processor 14 for transmission to other local conference participants through the local area radio 46, the local network 44, and the WCTs 40, 42.

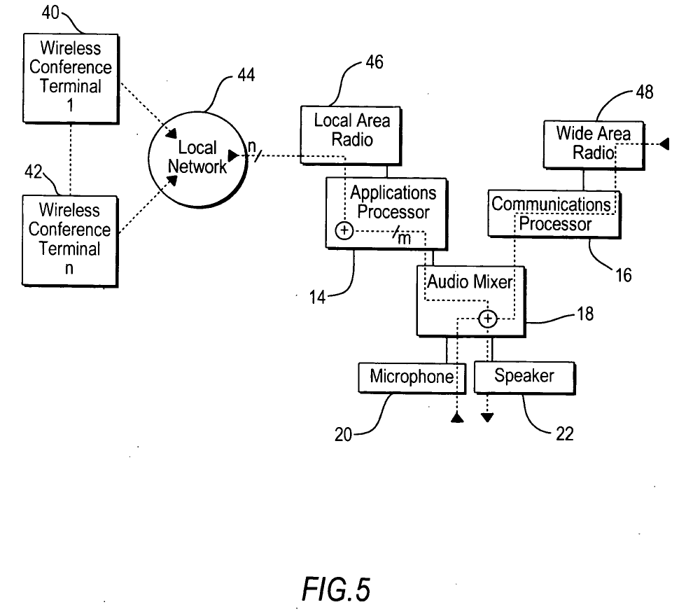

As shown in FIG. 5, the audio mixer 18 will also mix the audio streams received from the applications processor 14 from WCTs 40, 42, from the communications processor 12 receiving streams from GSM/CDMA systems through the wide area radio 48, and from the internal microphone 20, and send the resulting audio stream to the speaker 22.

In the present invention, audio mixing by the audio mixer module 18 may be performed partially in hardware. In one embodiment, the audio is mixed from all the incoming wireless streams in the applications processor, and then mixed in the received GSM audio in a hardware audio codec, before routing the mixed output to the speaker.

In another embodiment, all the mixing by the audio mixer module 18 is performed in software in the applications processor. Audio received over GSM/CDMA is transferred to the applications processor via an inter-CPU mechanism such as shared memory or message passing channels.

Multiparty support may also be supported. Using 802.11 and IP communication techniques to connect to multiple users provides a simple method to create a multiple party conference by means of IP multicast addresses. All parties in a conference can agree on a unique IP group and/or multicast address for the conference, and each participant transmits to that address.

In the present invention, the system and method are implemented using software operating with the various hardware and network components described herein as well as known communication devices.

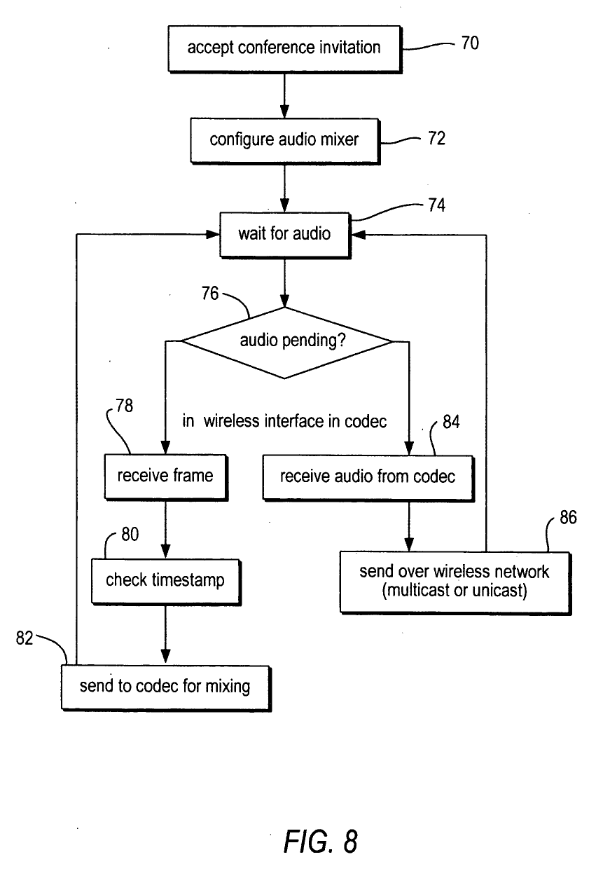

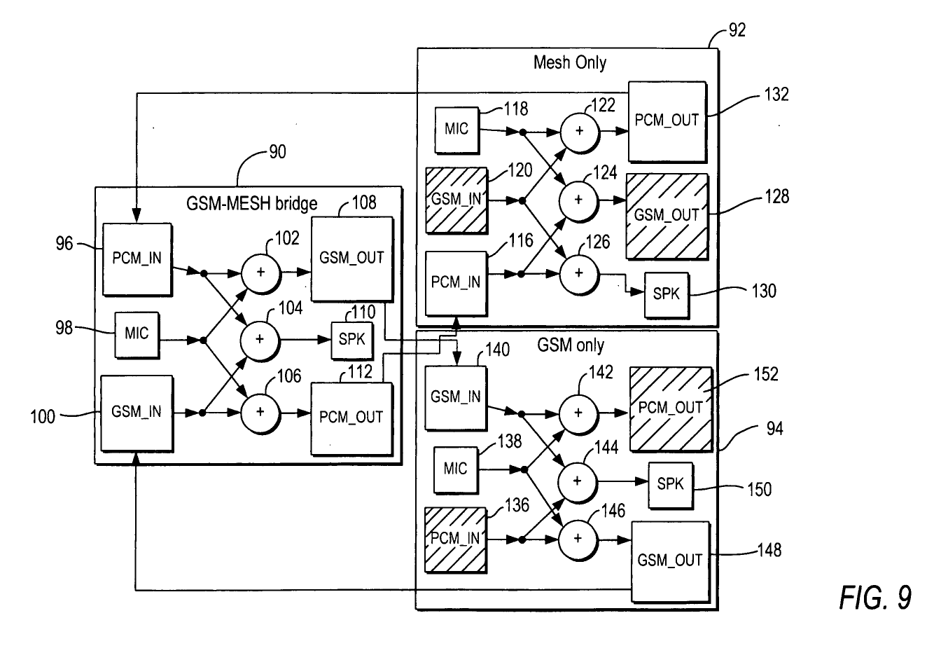

A first embodiment of the invention is implemented on a cellphone prototype, such as a prototype labeled Neo 1793, which has the architecture 10 described in FIG. 1. In a second embodiment, the telephone software is modified to present a user interface, for example, displaying various interfaces shown in FIGS. 6A-7E, and to operate according to the implementation of FIGS. 8-9.

In some embodiments, no wireless network card is provided, and so the present invention may alternatively be implemented by attaching an external card via a USB interface of the telephone.

A wireless mesh networking protocol is integrated on the phone that allows the phone to communicate over a wireless mesh. This networking protocol code may be publicly available under the General Public License, for example, publicly provide on a known website of o11s.org.

The present invention provides a modified audio streaming application, such as pulsaudio, to stream audio over the mesh network and configure the audio mixer to implement the audio paths described in FIGS. 3-5.

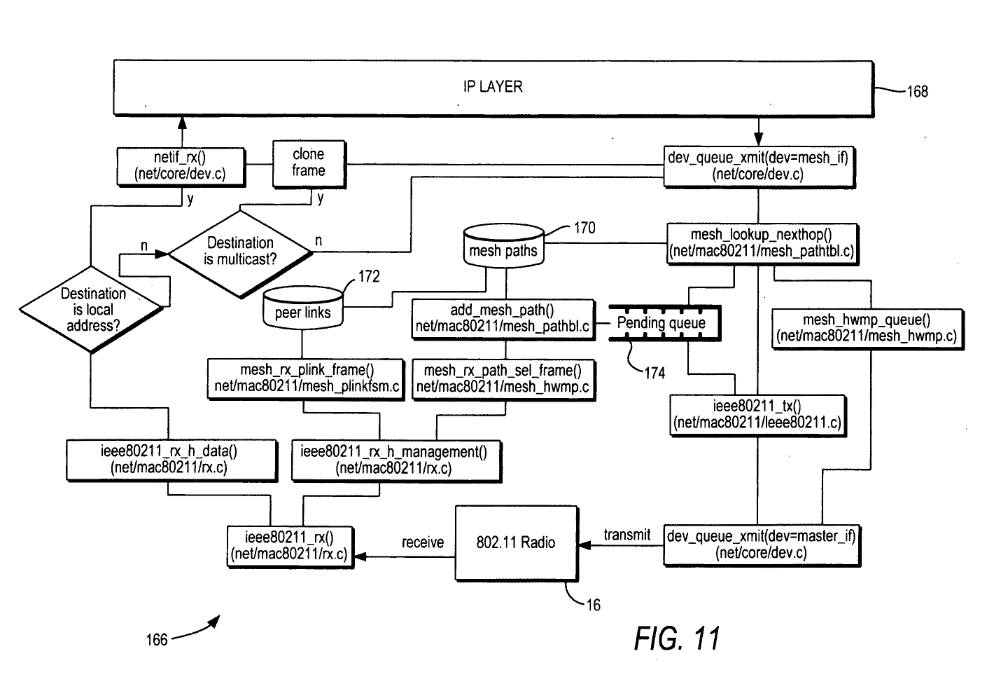

FIG. 8 shows a flowchart of a software application operating the system and method of the present invention. All the software may be written, for example, in the C programming language, and is stored on the re-writable non-volatile memory or flash memory of the telephone. The software application runs on the applications processor shown in FIG. 1 and bridges the audio. There are also changes to the phone user interface, as shown in FIGS. 6A-7E, and in the mixer configuration files. In addition, as shown in FIGS. 10-11, the mesh networking stack is integrated on the operating system in the applications processor, using, for example, the Linux operating system.

Referring to FIG. 8, the software application performs the steps of accepting a conference invitation in step 70, configuring the audio mixer 18 in step 72, and waiting for audio in step 74. The software checks if audio is pending in step 76. If audio is pending in a wireless interfaces, the software application performs step 78 to receive a frame, then checks a timestamp in step 80, and sends the audio to a codec for mixing in step 82, and the method loops back to step 74. However, after step 76, if audio is pending in a code, the software application performs step 84 to receive audio from the codec, and sends the audio over a wireless network in multicast or unicast form in step 86, and the method loops back to step 74.

FIG. 9 illustrates an audio codec configuration on three phones implementing the present invention in conjunction with the mesh networking stack shown in FIGS. 10-11, using either a GSM-MESH bridge 90, a Mesh Only configuration 92, and a GSM Only configuration 94.

In the GSM-MESH bridge 90, a PCM_IN module 96, a microphone 98, and a GSM_IN module 100 are connected to respective mixers 102-106 which are in turn connected to a GSM_OUT module 108, a speaker module 110, and a PCM_OUT module 112, with such components 96-112 implemented using known communication devices.

In the Mesh Only configuration 92, a PCM_IN module 116, a microphone 118, and a GSM_IN module 120 are connected to respective mixers 122-126 which are in turn connected to a GSM_OUT module 128, a speaker module 130, and a PCM_OUT module 132, with such components 116-132 implemented using known communication devices.

In the GSM Only configuration 94, a PCM_IN module 136, a microphone 138, and a GSM_IN module 140 are connected to respective mixers 142-146 which are in turn connected to a GSM_OUT module 148, a speaker module 150, and a PCM_OUT module 152, with such components 136-152 implemented using known communication devices.

As shown in FIG. 9, the GSM_OUT module 108 is in communication with the GSM_IN module 140, the PCM_OUT module 112 is in communication with the PCM_IN module 116, the GSM_OUT module 148 is in communication with the GSM_IN module 100, and the PCM_OUT module 132 is in communication with the PCM_IN module 96,

As shown in FIG. 10, the mesh networking stack is capable of establishing communications between communication devices 160-165, such as cellphones and computers including laptops using the communication layers 166, shown in FIG. 11, to provide a pre-802.11 is mesh network for Linux, which is vendor neutral, providing a pure layer 2 solution, with per-neighbor rate adaptation. Airtime link metrics may be used, with an on-demand hybrid wireless mesh protocol, mesh scanning, and multicast or broadcast frame forwarding with controlled flooding. Per-destination mesh statistics may be computed, mesh peer link establishment support may be provided, optionally without security, and the mesh networking stack is tested on ARM and x86 systems.

Referring to FIG. 11, the communication layers 166 are shown in greater detail, with the 802.11 radio 16 as shown in FIG. 1 interfacing with the IP layer 168 using various mesh paths 170, peer links 172, and a pending queue 174 as well as the various IEEE 802.11 processes shown in FIG. 11.

A second embodiment of the invention may be implemented on a commercial cellphone such as the “IPHONE” commercially available from “APPLE CORPORATION”). The phone manufacturer possibly may not provide to third-party application developers the means to mix GSM audio with other sources of audio available to applications, such as by microphone or wireless audio streams. However, in the described second embodiment, various features may be implemented such as peer discovery, peer authentication, mixing of multiple wireless streams in the applications processor, and local multi-party conferences.

As described herein, the host interface, such as a USB interface, the software language such as C, and the storage medium, such as Flash memory, are examples only, and may vary in other embodiments of the invention.

While the preferred embodiment of the present invention has been shown and described herein, it will be obvious that such embodiment is provided by way of example only. Numerous variations, changes and substitutions will occur to those skilled in the art without departing from the invention herein. Accordingly, it is intended that the invention be limited only by the spirit and scope of the appended claims.

What is claimed is:

1. A wireless networking system for providing communications among a plurality of wireless communication devices, the wireless networking system comprising:
a network selected from the group consisting of a wireless mesh, a wireless infrastructure, and a wireless ad-hoc network; and
a plurality of network components communicating over the network to allow a user, using a first wireless communication device, to invite and share conversations with other wireless communication devices in local spatial proximity to the first wireless communication device.

2. The wireless networking system of claim 1, wherein each of the plurality of wireless communication devices is selected from the group consisting of a cellphone, a wireless personal digital assistant, and a wireless-capable computer.

3. The wireless networking system of claim 1, wherein the wireless mesh includes an IEEE 802.11 mesh Basic Service Set system.

4. The wireless networking system of claim 1, wherein the wireless infrastructure includes an IEEE 802.11 infrastructure Basic Service Set system.

5. The wireless networking system of claim 1, wherein the wireless ad-hoc network includes an IEEE 802.11 independent Basic Service Set system.

6. The wireless networking system of claim 1, wherein the first wireless communication device includes:
a microphone;
a speaker;
an applications processor connected to the audio mixer for processing audio signals to and from the audio mixer and a local area radio; and
a communications processor connected to the audio mixer for processing audio signals to and from the audio mixer and a wide area radio;
wherein the plurality of network components includes at least one wireless conference terminal (WCT) connecting the first wireless communication device to the other wireless communication devices in local spatial proximity to the first wireless communication device.

7. A wireless networking system for providing communications among users, the wireless networking system comprising:
a wireless ad-hoc IEEE 802.11 network including an IEEE 802.11 independent Basic Service Set system; and
a plurality of wireless communication devices each associated with at least one of the users, wherein a first user, using a first wireless communication device, is capable of inviting and sharing conversations with other wireless communication devices in local spatial proximity to the first wireless communication device using the wireless ad-hoc IEEE 802.11 network.

8. The wireless networking system of claim 7, wherein each of the plurality of wireless communication devices is selected from the group consisting of a cellphone, a wireless personal digital assistant, and a wireless-capable computer.

9. A method of inviting wireless communication devices to share conversations over a wireless networking system, the method comprising the steps of:
providing a wireless ad-hoc IEEE 802.11 network, including an IEEE 802.11 independent Basic Service Set system, as the wireless networking system; and
providing a communication protocol for a first user, using a first wireless communication device, to invite at least one other wireless communication device in local spatial proximity to the first wireless communication device using the wireless ad-hoc IEEE 802.11 network.

10. The method of claim 9, wherein each of the plurality of wireless communication devices is selected from the group consisting of a cellphone, a wireless personal digital assistant, and a wireless-capable computer.
